(19) United States
(12) Patent Application Publication
(10) Pub. No.: US 2022/0280823 A1
(43) Pub. Date: Sep. 8, 2022

(54) MOTOR VEHICLE AND METHOD FOR INTRODUCING AN EXTINGUISHING AGENT INTO A BATTERY

(71) Applicant: AUDI AG, Ingolstadt (DE)

(72) Inventors: Dirk BAEDER, Fellbach (DE); Michael GRABOWSKI, Ingolstadt (DE)

(73) Assignee: AUDI AG, Ingolstadt (DE)

(21) Appl. No.: 17/680,608

(22) Filed: Feb. 25, 2022

(30) Foreign Application Priority Data
Mar. 5, 2021 (DE) 102021105356.0

(51) Int. Cl. A62C 37/11; A62C 3/16; H01M 10/0525; H01M 10/42

(52) U.S. Cl. CPC A62C 37/11; A62C 3/16; H01M 10/0525; H01M 10/42; H01M 2220/20; H01M 2200/10; B60L 50/60

(57) ABSTRACT

A vehicle having a battery, which has a battery housing and at least one battery cell arranged in the battery housing. The motor vehicle has an extinguishing agent line for guiding an extinguishing agent, which includes a first end which opens at least into the battery housing and a second end which opens into a region of the motor vehicle which is arranged in an interior of the motor vehicle. In this case, the second end has a coupling element for coupling to an extinguishing agent reservoir. The extinguishing agent line has a closure device releasable under at least one predetermined condition, which releases a supply of extinguishing agent through the first end into an interior of the battery housing only when the at least one predetermined condition is met.

### FIELD

The invention relates to a motor vehicle having a battery, which has a battery housing and at least one battery cell arranged in the battery housing. The motor vehicle furthermore comprises an extinguishing agent line for guiding an extinguishing agent, which comprises a first end which opens at least into the battery housing and has a second end which opens into a region of the motor vehicle which is arranged in an interior of the motor vehicle. Furthermore, the invention also relates to a method for introducing an extinguishing agent into a battery for a motor vehicle.

### BACKGROUND

Motor vehicle batteries, in particular high-voltage batteries, typically have numerous battery cells that can optionally be combined to form battery modules. In such high-voltage batteries, so-called thermal propagation, i.e., thermal runaway, of a battery cell can occur under certain circumstances, for example in the event of an accident or a short circuit within the battery. Such a thermal runaway of a battery cell is initially expressed in an increasing temperature of this battery cell, which then usually bursts into flames or explodes if no countermeasures are taken. Due to the strong temperature development, there is usually also a thermal runaway of battery cells arranged adjacent to one another, until this thermal propagation ultimately propagates through the entire high-voltage battery, which then ultimately catches fire as a whole. Once such a high-voltage battery is on fire, it can usually only be extinguished with difficulty and can also normally only be extinguished by the fire department using special tools, for example, an extinguishing lance that is fired through the vehicle floor to flood the battery housing. It would therefore be desirable to be able to stop such thermal propagation as early as possible or at least to be able to delay it for as long as possible, in particular in order to be able to create additional rescue minutes for passengers as a result.

In this context, EP 3 204 978 B1 describes a battery system for a vehicle having inclines for distributing cooling water. The extinguishing water can be better distributed over the individual battery modules by an incline having through openings provided above the battery modules. The extinguishing water can be supplied to the distribution device here via an opening in the interior of the motor vehicle, for example in the passenger compartment. The fire department can accordingly direct the fire hose at this opening in order to supply extinguishing water to the distribution device to extinguish the battery or to flood the interior of the motor vehicle. In this case as well, the battery can only be extinguished when the fire department has arrived.

Furthermore, DE 10 2008 059 948 A1 describes a method and a device for fire prevention and/or firefighting for a lithium-ion battery of a vehicle, in which an extinguishing agent is introduced into an interior of a motor vehicle battery via an emergency line. The extinguishing agent can be stored in an extinguishing agent storage device in the motor vehicle. This extinguishing agent storage device can also be provided by a coolant circuit of the motor vehicle, wherein CO₂ is used as the coolant. Although a fire can be fought by means of CO₂ do to its suffocating effect, firefighting again takes place at a very late point in time here. The shared use of a coolant as an extinguishing agent also has the disadvantage that there is no possibility of optimizing the relevant fluid with regard to its function to be executed. The provision of a separate extinguishing agent tank, on the other hand, has the disadvantage that additional installation space has to be provided in the motor vehicle for this purpose, which is then ultimately permanently reserved for accommodating the extinguishing agent tank.

Furthermore, KR 20180003272 U describes a fire extinguisher for a motor vehicle for extinguishing an engine fire. This can be connected via a quick coupling to a line provided on the hood leading into the engine compartment in order to extinguish an engine fire. However, this has the disadvantage that the extinguishing measures have to be carried out manually by a user for this purpose. If a battery and not an engine catches fire, such a manual extinguishing measure would no longer be executable by a user.

Furthermore, US 2012/0168184 A1 describes a fire-fighting system for a container, which has two tanks that are filled with a respective liquid component which, in case of a fire, is mixed to form a two-part foam and can be discharged in mixed form through nozzles similarly to a sprinkler system. Such a system can also be integrated into a motor vehicle to extinguish a battery. The enormous disadvantage also results here that the permanently installed tanks take up an extremely large amount of installation space when such a system is integrated into a motor vehicle, which accordingly is no longer flexibly usable.

### SUMMARY

The object of the present invention is therefore to provide a motor vehicle and a method that make it possible to introduce an extinguishing agent into a battery as early and as flexibly as possible.

A motor vehicle according to the invention has a battery which has a battery housing and at least one battery cell arranged in the battery housing. The motor vehicle furthermore comprises an extinguishing agent line for guiding an extinguishing agent, which comprises a first end which opens at least into the battery housing and has a second end which opens into a region of the motor vehicle which is arranged in an interior of the motor vehicle. The second end has a coupling element for coupling to an extinguishing agent reservoir, wherein the extinguishing agent line has a closure device releasable under at least one predetermined condition, which releases the supply of extinguishing agent through the first end into an interior of the battery housing only when the at least one predetermined condition is met.

The invention thus advantageously makes it possible to flexibly connect an extinguishing agent reservoir, such as a fire extinguisher, to the extinguishing agent line so that, for example, the extinguishing agent from the fire extinguisher can be introduced into the battery as needed in the state of the fire extinguisher connected to the extinguishing agent line. This results in numerous advantages compared to previous extinguishing concepts: On the one hand, this enables a battery to be extinguished or cooled early, in particular before a battery fire has even started and, for example, also before a fire department arrives at the scene of an accident. For example, the closure device can be released automatically as soon as some type of critical status of the at least one battery cell, for example an elevated temperature, is established. The extinguishing agent can then advantageously be introduced into the battery automatically without the user having to do anything. An initiation can thus also take place without the presence of a user, who in the meantime can move out of the vehicle and to safety. Furthermore, the flexible and, above all, reversible coupling option of the extinguishing agent reservoir makes it possible to flexibly connect it to the extinguishing agent line, to decouple it from it, and to replace it. For example, multiple fire extinguishers can also be carried by a driver in the vehicle and, in an emergency, can be connected to the extinguishing agent line sequentially in time. If one extinguishing agent reservoir is thus already empty, then if there is a need for additional cooling or extinguishing, another extinguishing agent reservoir that is carried can simply be connected to the extinguishing agent line. These extinguishing agent reservoirs, which are also referred to simply as fire extinguishers below for the sake of simplicity, can then carried be distributed anywhere in the motor vehicle, for example depending on the available installation space. For example, after the arrival of the fire department, a new fire extinguisher that is still full can be connected to the extinguishing agent line. In addition, it is also advantageously possible to uncouple the fire extinguisher and use it, for example, to extinguish another source of fire, for example also another vehicle. Even if there is no need to extinguish, extinguishing agent reservoirs, such as fire extinguishers, also have to be regularly maintained or replaced in order to ensure perfect functionality in an emergency. With extinguishing agent reservoirs permanently integrated into the vehicle, this would involve a great deal of effort. The present invention advantageously makes it possible to simply replace a fire extinguisher with a new one even if it has not been used after multiple years. The region in the motor vehicle interior accessible to a user, in which the second end having the coupling element for coupling to the fire extinguisher opens, can also be relatively small. This only has to be designed to accommodate a small extinguishing agent reservoir, for example a small fire extinguisher, for example having a volume between 500 milliliters and 2 liters or generally between 0.3 liters and 5 liters. Nevertheless, this region can still be used flexibly, since the fire extinguisher does not necessarily have to be permanently coupled to the coupling element. In principle, it is also conceivable to store this fire extinguisher in a different position and then to connect it to the coupling element only in an emergency. Overall, the invention thus provides numerous options, on the one hand, for supplying an extinguishing agent to a battery very early and at the same time enabling an extremely flexible use of installation space.

As mentioned at the outset, the battery can be a high-voltage battery. In addition, the battery can also have multiple battery cells accommodated in the battery housing. For example, the battery can also comprise multiple battery modules, each having multiple battery cells. The term battery cell is to be understood as an individual cell. The battery cells or the at least one battery cell can be designed as a lithium-ion cell, for example. The extinguishing agent line can made be at least partially or completely flexible, for example as a hose, and/or at least partially or completely rigid, for example as a pipe. The fact that the first end of the extinguishing agent line opens at least into the battery housing is to be understood to mean that under certain circumstances, for example if a battery module is arranged in the battery housing, which in turn has a module housing in which the at least one battery cell is accommodated, this line can also lead directly into the module housing. The extinguishing agent line is preferably also designed in such a way that an extinguishing agent is introducible into the battery in such a way that this introduced extinguishing agent can be brought into direct contact with the at least one battery cell and can contact the cell housing directly, for example. This in turn is based on the knowledge that direct contact with a battery cell that is thermally running away is the most efficient way to stop or at least delay this thermal runaway, even if this possibly increases the risk of short circuit, depending on how the extinguishing agent is used. The cooling effect of the extinguishing agent can thus develop most effectively and the thermal runaway can be delayed or even completely prevented from spreading to other battery cells.

In order to enable even more efficient stopping of a thermal runaway of at least one battery cell, especially when the battery comprises multiple battery cells, it is preferred that the battery has, for example, a distribution device that enables an extinguishing agent to be selectively supplied to a respective battery region, wherein the battery correspondingly has multiple such battery regions, wherein at least one battery cell is accommodated in a respective battery region. For example, a battery module having multiple battery cells in each case can be arranged in a respective battery region. The battery regions can be spatially separated from one another and can be provided, for example, by respective chambers of the battery housing. However, the battery regions can also be provided by battery modules themselves, which in turn each have a separate module housing. In other words, such a distribution device makes it possible to supply the extinguishing agent to a battery module in a targeted manner, so that it is brought into direct contact with the respective battery cells of this battery module without other battery modules and their cells being affected thereby. The risk of short-circuiting other battery cells that are still intact can be reduced in this way, while at the same time thermal propagation of an affected battery cell can be prevented by directly introducing the extinguishing agent. Such a distribution device, in particular in combination with the respective spatially separated battery regions, also has the great advantage that this enables particularly efficient extinguishing or cooling of the affected battery cell, even if only an extremely limited amount of extinguishing agent is available. This can be introduced in a targeted manner into the spatially limited region having the affected battery cell so that it can be efficiently cooled. As a result, significantly less extinguishing agent is accordingly required than if it were distributed over an entire high-voltage battery. In order to provide such a distribution device, the extinguishing agent line can, for example, branch in the direction of its first end and can have multiple first ends, each of which opens into a corresponding battery region. In this case, a respective second end of the extinguishing agent line can be provided with a corresponding valve or another closure device that enables selective opening.

In addition, in the scope of the present invention, an extinguishing agent can also be understood to mean a coolant. In other words, the extinguishing agent should not only be used to extinguish a battery fire, but also even before a fire occurs, for example to cool an overheated battery cell and thus prevent a fire from breaking out.

Furthermore, it is preferred that the second end opens into a region of the motor vehicle that is a region accessible to a user. This facilitates the replacement of the fire extinguisher, for example. In addition, the coupling element can be designed for reversible coupling to the extinguishing agent reservoir. This enables non-destructive decoupling of the extinguishing agent reservoir, for example for the purpose of replacement.

In a further very advantageous embodiment of the invention, the extinguishing agent line is designed in such a way that when the extinguishing agent reservoir having an extinguishing agent accommodated in the extinguishing agent reservoir is coupled to the coupling element and when the at least one predetermined condition is met, the extinguishing agent can automatically be guided into the interior of the battery housing by releasing the closure device. This has the great advantage that the extinguishing agent can be supplied into the interior of the battery housing automatically without the user having to do anything. This enables an extinguishing agent to be introduced into the battery in a timely and especially early manner for the case of beginning thermal propagation. The extinguishing agent reservoir can, for example, be permanently coupled to the extinguishing agent line and carried in the motor vehicle. As soon as, for whatever reason, an anomaly is detected in the battery that indicates a possible thermal event, an extinguishing agent supply can also be triggered immediately and without time delay. The extinguishing agent accommodating in the extinguishing agent reservoir can then be introduced directly into the battery via the extinguishing agent line when the closure device is released.

In a further very advantageous embodiment of the invention, the coupling element is designed as part of a quick coupling. This allows the extinguishing agent reservoir to be easily and quickly plugged onto the second end of the extinguishing agent line, as well as a very simple decoupling of the extinguishing agent reservoir from the extinguishing agent line. In addition, such a quick coupling enables a fluid-tight connection between the extinguishing agent reservoir and the extinguishing agent line. The coupling element can be designed, for example, as a first part of such a quick coupling, wherein the extinguishing agent reservoir is designed having a corresponding second part of such a quick coupling. The first and second part can then each be designed as a male or corresponding female part, respectively, of such a quick coupling. The two complementary parts of such a quick coupling can thus be simply plugged into one another and unplugged again.

Furthermore, it is particularly advantageous if the closure device is integrated in the coupling element. This prevents the extinguishing agent from being able to penetrate into the extinguishing agent line as long as the closure device is closed. This means that the battery can be kept safely away from the extinguishing agent as long as there is no critical status. The extinguishing agent therefore only penetrates into the extinguishing agent line or into that part of the extinguishing agent line that is different from the coupling element and the closure device in an emergency. This means that, should no emergency arise, no maintenance or cleaning of this extinguishing agent line is required. No extinguishing agent can penetrate into the extinguishing agent line beforehand and possibly adhesively bond or partially block it.

In a further very advantageous embodiment of the invention, the first condition is met if a critical status of the at least one battery cell is detected according to a predetermined criterion, in particular if a temperature inside the battery housing is greater than a predetermined limiting value, which is between 60 degrees Celsius and 80 degrees Celsius inclusive. The release of the closure device as a function of the temperature in the battery, in particular in the vicinity of the at least one battery cell, is particularly advantageous since a beginning thermal runaway of a cell can be detected particularly reliably based on the temperature. In addition, the temperature can be detected easily, since multiple temperature sensors are already installed in a high-voltage battery and the temperature is also detected in any case for monitoring purposes. Especially when the temperature associated with a battery cell rises to 60 to 80 degrees Celsius, thermal runaway is very likely to be beginning, which can no longer be stopped without countermeasures. At the same time, there is usually not yet a fire at a temperature between 60 and 80 degrees Celsius. There is still enough time to prevent a possible battery fire, which can be achieved by supplying the extinguishing agent to the battery immediately. The motor vehicle can therefore have a temperature sensor or, in general, a detection device which is designed to detect the temperature associated with the at least one battery cell or, in general, a temperature within the battery housing and to transmit a signal to the closure device if the limiting value is exceeded. Accordingly, the closure device opens immediately after receiving the signal.

In a further very advantageous embodiment of the invention, the coupling element is designed for coupling to an extinguishing agent reservoir designed as a fire extinguisher, in particular a lithium-ion fire extinguisher. The coupling element can also still be provided as part of a quick coupling. Such a fire extinguisher can also have a complementary part of such a quick coupling for connection to the coupling element. If necessary, an adapter part can also be provided, via which a conventional fire extinguisher can be connected to a quick coupling connection. The possibility of connecting a conventional fire extinguisher to a quick coupling connection, with or without an adapter, is particularly advantageous, since in this way lithium-ion fire extinguishers can be provided and used in a standardized manner, which enormously simplifies the replacement of a fire extinguisher. It is also possible to use such a fire extinguisher independently of the coupling to the extinguishing agent line. This enables, for example, in case of another source of fire, this also to be extinguished by means of the fire extinguisher. This allows even more flexible application options. Extinguishing media, for example, liquefied vermiculite, in particular based on a dispersion, or water-foam mixtures are particularly suitable for extinguishing motor vehicle batteries, in particular lithium-ion batteries. The extinguishing agent preferably fulfills multiple functions here, such as cooling and oxygen exclusion, and is preferably very temperature-resistant and non-flammable, in particular if a foam or water-foam mixture is used. An extinguishing gas, for example CO₂ or N₂, can also be provided as an extinguishing agent. Instead of a conventional fire extinguisher, for example, a pressure tank as an extinguishing agent reservoir, in particular having an expansion unit, is then also conceivable. Such an expansion unit advantageously enables expansion cooling. The expansion unit can be provided, for example, in the region of the coupling element, but preferably in the region of the first end of the extinguishing agent line. This makes it possible to expand a gas in such a way that it cools down very strongly, in particular below 0 degrees, in particular also below −20 degrees Celsius. This allows the battery cells in question to be frozen, as a result of which the thermal runaway can be interrupted or delayed in a particularly efficient manner. Efficient cooling of the at least one battery cell can thus also be provided using an extinguishing gas in case of a thermal runaway. There is thus advantageously the possibility of locally extinguishing thermal propagation of individual battery cells immediately after detection using a fire extinguisher or freezing it by means of expansion cooling.

Furthermore, it is advantageous if the coupling element is designed, for example, in such a way that a closure closing the extinguishing agent reservoir in the state not coupled to the coupling element is opened by the coupling element at least for a duration of the coupling to the coupling element when the extinguishing agent reservoir is coupled to the coupling element. In other words, it can be provided that a closure which closes the extinguishing agent reservoir in the uncoupled state in order to prevent the extinguishing agent from escaping from the extinguishing agent reservoir is automatically opened as soon as this extinguishing agent reservoir is coupled to the coupling element. The closure can be opened by a device of the coupling element. Such a closure can also be reversibly closable by means of the coupling element. If, for example, the extinguishing agent reservoir is uncoupled again while it is still full, this closure associated with the extinguishing agent reservoir can also be closable again automatically. Alternatively, such a closure can also be manually releasable upon coupling to the coupling element. For example, when a user connects the extinguishing agent reservoir, for example a fire extinguisher, to the coupling element, he can manually unlock the fire extinguisher in order to arm it, so to speak. Nevertheless, the closure device associated with the extinguishing agent line ensures that no extinguishing agent enters the battery at this point in time. Only when the predetermined condition is met is the closure device of the extinguishing agent line finally released automatically and the extinguishing agent can be guided automatically into the battery.

The region in the interior of the motor vehicle that is accessible to the user does not necessarily have to be limited to a passenger compartment. The interior of the motor vehicle is basically any region that cannot be accessed from outside the motor vehicle without the use of force when the motor vehicle is in the closed state. This also includes, for example, a luggage compartment, in particular a rear luggage compartment, or an area under the hood or front luggage compartment. It is particularly advantageous if the region of the motor vehicle accessible to the user is arranged under a seat of the motor vehicle, in particular a driver's seat, and/or in the region of a center console of the motor vehicle and/or in the region of the rear center console of the motor vehicle and/or in a footwell on the front passenger side of the motor vehicle and/or in a luggage compartment of the motor vehicle. There is typically sufficient space in particular under the front seat of a motor vehicle and also at the other positions mentioned, above all in the center console region, to be able to position at least a small fire extinguisher there. In addition, this region is also easily accessible for a user. In the same way, however, it is also conceivable to provide this region in a rear seat bench of the motor vehicle. In particular, the region under a front seat and the region of the center console also have the great advantage that here the distance to the battery of the motor vehicle, which is usually arranged under the floor of the passenger compartment, is particularly short. As a result, the extinguishing agent line can be made very short. A short line in turn has the great advantage that the risk of a possible blockage or clogging of such a line is minimized. Due to this short embodiment of the extinguishing agent line, the extinguishing agent can also be supplied to the battery particularly quickly. Longer line paths are also much more difficult to clean, for example after a triggering event. Accordingly, these positions of this region in the interior that is accessible to the user are particularly advantageous. Another major advantage of these positions or the route of the extinguishing agent line from one of these positions to the battery is that in case of a crash, it is less likely that a supply line will be damaged in this position, since the interior region around the passengers is a maximally protected space. In addition, the battery housing, which is located directly under the passenger compartment, is also very well protected in case of a crash, since it is important for the battery that there is as little intrusion into the battery housing as possible in case of a crash. As a result, in very many situations there is no relative movement between the battery and the passenger compartment, which accordingly also protects a supply line at this position in the best possible manner. Nevertheless, the extinguishing agent reservoir can also be arranged in a luggage compartment of the motor vehicle or the region accessible to the user can be provided there, into which the second end of the extinguishing agent line opens. In the rear luggage compartment in particular, for example in the region of a spare wheel recess, there is typically sufficient space to be able to provide such an extinguishing agent reservoir. In addition, this region is also particularly easily accessible, so that it is very easy for a user to replace the fire extinguisher. Nevertheless, other positions for the region accessible to the user are also conceivable.

In a further very advantageous embodiment of the invention, the motor vehicle comprises a second extinguishing agent line for guiding an extinguishing agent, which has a third end, which opens into the battery housing or into the first extinguishing agent line, and has a fourth end, which opens into a second region of the motor vehicle accessible to a user, which is arranged in an interior of the motor vehicle, wherein the fourth end has a second coupling element for reversible coupling to an extinguishing agent reservoir. In other words, multiple such coupling points can be provided for coupling to an extinguishing agent reservoir. This has multiple advantages at the same time. On the one hand, for example, the user can choose which extinguishing agent line he would like to couple an extinguishing agent reservoir to, for example a fire extinguisher. He can then decide this according to the available installation space or his desired use with respect to this installation space. In addition, it is also possible to couple a respective extinguishing agent reservoir, for example a respective fire extinguisher, to both coupling elements at the same time. As a result, the amount of extinguishing agent that can ultimately be provided can be doubled. This means that the extinguishing process can be made even more efficient in an emergency. The redundant provision of extinguishing agent also offers an increased level of safety, for example for the case of a defect in an extinguishing agent line. Accordingly, it is advantageous if, for example, the two extinguishing agent lines are embodied separately from one another, which means that the third end of the second extinguishing agent line does not open into the first extinguishing agent line, but directly into the battery. This in turn has the advantage that the line path from the fourth to the third end can be made shorter, which has the advantages described above. This also provides the possibility that, for example, the first extinguishing agent line can be used to extinguish a front half of the battery and the second extinguishing agent line to extinguish a rear half of the battery, for example when the battery is divided into corresponding battery regions as described above. In principle, it is also conceivable for the motor vehicle to have more than two extinguishing agent lines with corresponding ends opening into the interior of the motor vehicle for coupling to respective extinguishing agent reservoirs. This can be implemented in a simple manner without an additional large installation space expenditure, since only the corresponding connections, namely the relevant coupling elements, have to be provided in the interior region without necessarily having to also connect an extinguishing agent reservoir thereon.

In a further advantageous embodiment of the invention, the extinguishing agent line has an intermediate reservoir which is fillable with extinguishing agent via the extinguishing agent reservoir coupled to the coupling element, wherein the closure device is arranged in a line region of the extinguishing agent line between the intermediate reservoir and the first end of the extinguishing agent line. This makes it possible, for example via a fire extinguisher, to fill such an extinguishing agent reservoir integrated in the vehicle, which is referred to here as an intermediate reservoir. This can also be done via a quick coupling as described above. The fire extinguisher is therefore easily connectable to the coupling element and thus also enables, for example, only manual filling of the intermediate reservoir and can then be uncoupled from the coupling element again, which automatically closes the access to the extinguishing agent line and thus also to the intermediate reservoir. However, the extinguishing agent path from the intermediate reservoir to the battery is only released when a critical state of the battery or the at least one battery cell is detected. Accordingly, it is advantageous in this case if the closure device is arranged on this supply path in the supply direction after the intermediate reservoir, for example at an outlet of the intermediate reservoir. In contrast to a fire extinguisher, such an intermediate reservoir has the advantage that it is geometrically adaptable to the existing installation space situation in the motor vehicle. Due to the possibility of coupling with a fire extinguisher, it can also be refilled particularly easily and flexibly. Nevertheless, this represents a less preferred embodiment variant. The extinguishing agent line is preferably designed without such an intermediate reservoir, which has the advantage that a fixed, predetermined installation space is not permanently reserved for such an intermediate reservoir.

The motor vehicle according to the invention is preferably designed as an automobile, in particular as a passenger car or truck, or as a passenger bus or motorcycle. In addition, the motor vehicle is preferably designed as an electric vehicle or hybrid vehicle.

Furthermore, the invention also relates to a method for introducing an extinguishing agent into a battery for a motor vehicle, wherein the extinguishing agent is guided into the battery via an extinguishing agent line, and wherein the extinguishing agent line comprises a first end which opens at least into a battery housing of the battery, and has a second end which opens into a region of the motor vehicle which is arranged in an interior of the motor vehicle. A coupling element of the second end is coupled to an extinguishing agent reservoir comprising the extinguishing agent, and a closure device of the extinguishing agent line releasable under at least one predetermined condition is opened when the at least one predetermined condition is met, in order to enable the extinguishing agent to be supplied into an interior of the battery housing.

The advantages mentioned for the motor vehicle according to the invention and its embodiments apply in the same way to the method according to the invention.

The invention also includes refinements of the method according to the invention, which have features as already described in the context of the refinements of the motor vehicle according to the invention. For this reason, the corresponding refinements of the method according to the invention are not described again here.

The invention also comprises combinations of the features of the described embodiments. The invention thus also comprises implementations that each have a combination of the features of several of the described embodiments, provided that the embodiments were not described as mutually exclusive.

### BRIEF DESCRIPTION OF THE FIGURES

Exemplary embodiments of the invention are described hereinafter. In the figures:

FIG. 1 shows a schematic representation of a motor vehicle having an extinguishing agent line which opens into a motor vehicle battery and to which an extinguishing agent reservoir in the form of a fire extinguisher is connected, according to one exemplary embodiment of the invention; and

FIG. 2 shows a schematic representation of part of an interior of the motor vehicle having an extinguishing agent line which opens in the center console region behind the front seats and to which an extinguishing agent reservoir in the form of a fire extinguisher is connected.

The exemplary embodiments explained hereinafter are preferred embodiments of the invention. In the exemplary embodiments, the described components of the embodiments each represent individual features of the invention that are to be considered independently of one another and that also refine the invention independently of one another. Therefore, the disclosure is also intended to encompass combinations of the features of the embodiments other than those illustrated. Furthermore, the described embodiments can also be supplemented by further ones of the above-described features of the invention.

In the figures, the same reference numerals designate elements that have the same function.

### DETAILED DESCRIPTION

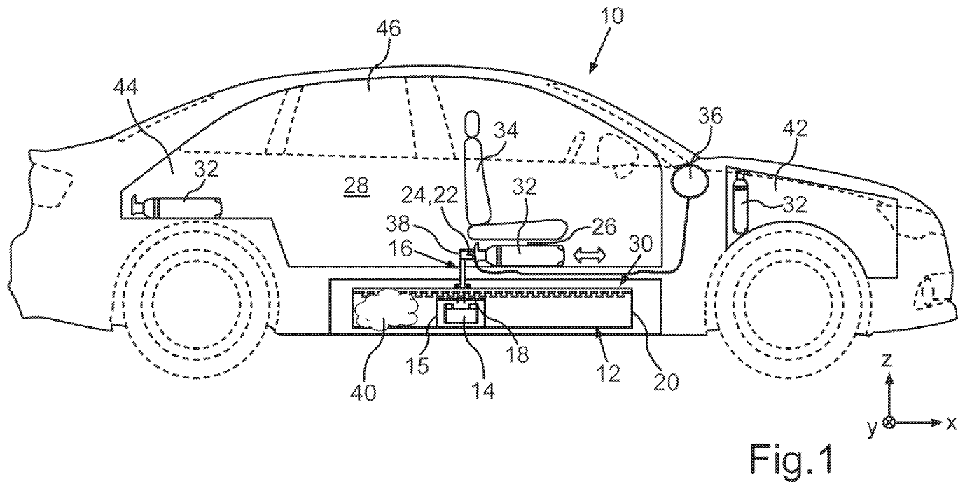

FIG. 1 shows a schematic representation of a motor vehicle 10 having a battery designed as a high-voltage battery 12, which has at least one battery cell 14, for example a lithium-ion cell, but preferably a plurality of such battery cells 14, of which only one is shown as an example in the figure. The battery cell can be part of a battery module 15, in particular comprising multiple battery cells 14, wherein the high-voltage battery 12 can also have multiple such modules 15. The motor vehicle furthermore comprises an extinguishing agent line 16. This has at least a first end 18, which opens into the battery 12, in particular into a battery housing 20 of the battery, in which the at least one battery cell 14 is accommodated, and a second end 22, which comprises a coupling element 24 and which opens into a region 26 of the motor vehicle 10 which is accessible to a user and which is arranged in an interior 28 of the motor vehicle 10. In this example, the extinguishing agent line has multiple first ends 18, of which only one is provided with a reference numeral for reasons of clarity. These multiple first ends 18 form a distribution system 30. This distribution system 30 can be designed, for example, to distribute the extinguishing agent introduced into the battery 12 through the extinguishing agent line 16 as uniformly as possible over the entire battery surface. However, it is particularly advantageous if such a distribution system 30 is designed to introduce the extinguishing agent selectively into individual regions of the battery 12 that are spatially separated from one another, for example directly into the respective battery modules 15 affected, as shown in FIG. 1. For this purpose, for example, each end 18 of the multiple first ends 18 arranged distributed in the x-y plane shown here can be provided with a corresponding valve. These valves can be designed to be activatable independently of one another, so that those valves that are assigned to a corresponding battery region or battery module 15 in which the battery cell 14 is located that is in a critical state can be activated in a targeted manner. Even if only a limited amount of extinguishing agent is available, effective extinguishing or also cooling of such a battery cell 14 can be provided because the extinguishing agent can be introduced in a targeted manner into the spatially separated region in which this battery cell 14 is accommodated.

However, it is particularly advantageous that an extinguishing agent reservoir, such as a fire extinguisher 32 shown in this example, in particular a lithium-ion fire extinguisher, can be reversibly coupled to the coupling element 24 of the second end 22 of the extinguishing agent line 16. Such a fire extinguisher 32 can advantageously be integrated, at least temporarily, into the vehicle 10, for example under the seat structure, under the front seat 34 as in this example. As shown, the fire extinguisher 32 is connected via the coupling element 24, which is preferably designed as a quick coupling, to the supply line provided by the extinguishing agent line 16, which, after triggering, conducts extinguishing medium accommodated in the fire extinguisher 32 into an optional extinguishing agent distribution unit, the mentioned distribution system 30, inside the high-voltage battery. The quick coupling 24 can be connected to the vehicle architecture, in particular the electrical or electronic vehicle architecture, for example the vehicle electrical system 36, and can be triggered automatically in case of thermal propagation, which is detected for example by sensors in the high-voltage battery 12. This triggering event can be detected in the vehicle electrical system 36 and the quick coupling 24 can be activated accordingly in order to open a closure device 38 integrated in the quick coupling 24. Opening this closure device 38 releases the extinguishing agent path from the second end 22 of the extinguishing agent line to at least one of the first ends 18 of the extinguishing agent line 16, as a result of which the extinguishing agent can be introduced into the battery 12 to cool the relevant battery cell 14 or to extinguish a fire 40 that may have already started. As described, the extinguishing agent distribution unit, that is to say the distribution system 30, can introduce the extinguishing medium locally into one or more battery cells 14, which are currently undergoing thermal propagation. This can be detected via a temperature increase at temperature sensors that are arranged distributed in the high-voltage battery 12. With the detection of a critical state of the battery cell 14, an automatic emergency call, for example an eCall, can also be triggered at the same time. In the meantime, i.e., even before the arrival of the fire department, the extinguishing or cooling process can now advantageously be started in order to prevent or at least delay the spread of thermal propagation. This creates valuable rescue minutes for passengers.

Such a fire extinguisher 32 or also multiple fire extinguishers 32 can be located under multiple seats 34, but also in the front luggage compartment 42, which is also to be considered to be part of the interior 28, and also in the rear luggage compartment 44 as part of the interior 28, in the roof region of the interior 28, and so on. A combination of multiple fire extinguishers 32 at different positions in the interior 28 of the motor vehicle 10 is also possible. In this way, dead spaces, for example typically the spare wheel recess or the like, can be used efficiently. Correspondingly, a corresponding quick coupling 24 can also be provided at the respective positions mentioned as part of a corresponding extinguishing agent line 16, the other end of which opens into the battery 12. The shorter the path to be covered by the extinguishing agent line 16 to the battery 12, the better. Accordingly, a position, for example, below a front seat 34, as shown here, is particularly advantageous.

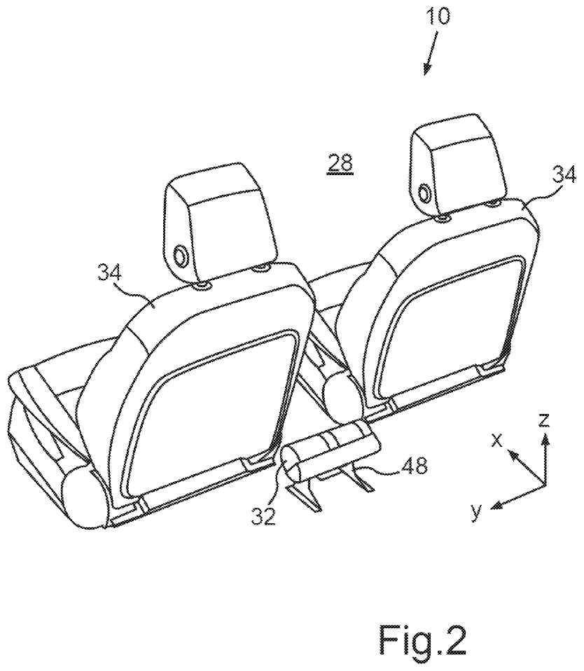

A further advantageous position is also shown in FIG. 2, which shows part of the interior 28 of the motor vehicle 10, wherein in this example the second end 22 having the coupling element 24 and an extinguishing agent reservoir connected thereon and designed as a fire extinguisher 32 is arranged in a region 48 of a center console behind the front seats 34 and in front of, for example, a rear bench seat (not shown). In this example, this region 48 is located in a center with respect to the vehicle transverse direction, which corresponds to the y direction shown here.

The quick coupling 24 also has the advantage that a user can remove the relevant fire extinguisher 32 in order, for example, to also extinguish a fire outside the vehicle as a first responder. A further advantage is that the user or the fire department can replace an empty fire extinguisher cartridge 32 for a new, i.e., full one. A fire extinguisher 34 also has an expiration date, so that it is also very advantageous to be able to easily replace it during service. In addition, the installation space available in motor vehicle 10 can be used much more efficiently. If, for example, multiple such extinguishing agent lines 16 are provided, a user can also decide for himself, for example, at which point he would like to position a fire extinguisher 32, depending on the installation space available.

The quick coupling 24 can also provide a mechanism that makes it possible to automatically arm the fire extinguisher 32 upon coupling, that is to say to open a closure device associated with the fire extinguisher 32. This provides a particularly convenient coupling option, since the fire extinguisher 32 is thus immediately ready for use in the coupled state. The automatic opening of such a closure can also be controlled electrically, for example. Alternatively, it can also be provided that a user first has to carry out such an unlocking step to unlock the fire extinguisher 32. However, the user can still do this in a simple manner when he couples the fire extinguisher to the quick coupling 24. For this purpose, the user can, for example, as is known from conventional fire extinguishers, remove an unlocking pin from the fire extinguisher 32 and, for example, press or activate the lever of the fire extinguisher 32, as during the normal use of a fire extinguisher to release the extinguishing agent. For this purpose, the fire extinguisher can also be designed having a locking device and/or such a locking device for locking this lever can be provided on the vehicle side. Nevertheless, this arming of the fire extinguisher 32 does not result directly in the exit of the extinguishing agent from the fire extinguisher 32, which is ensured by the closure device 38 of the extinguishing agent line 16, which is preferably integrated into the quick coupling 24. Even when the fire extinguisher 32 is in the armed state, the extinguishing agent is thus efficiently prevented from penetrating into the extinguishing agent line 16 before it is triggered or before a critical state of a battery cell 14 is detected.

Overall, the examples show how the invention can provide a battery extinguishing method using a fire extinguisher, which makes it possible to enormously reduce the reaction rate in the case of thermal propagation due to the rapid readiness for use and thus to effectively reduce the rescue time until the fire department arrives or while the fire department is already working on the rescue. Due to the very early readiness for use, there is generally significantly less damage to the entire vehicle in case of thermal propagation of a battery cell. In addition, by providing a distributor unit as described above, for example, it is possible that intact battery cells are not unnecessarily negatively influenced by the coolant. Overall, increased safety for the fire department and bystanders and infrastructure elements is achieved. In addition, the invention also offers a high potential for cross-industry norming and standardization.

1. A motor vehicle comprising: a battery, which has a battery housing and at least one battery cell arranged in the battery housing, wherein the motor vehicle has an extinguishing agent line for guiding an extinguishing agent, which comprises a first end which opens at least into the battery housing and has a second end which opens into a region of the motor vehicle which is arranged in an interior of the motor vehicle, wherein the second end has a coupling element for coupling to an extinguishing agent reservoir, wherein the extinguishing agent line has a closure device releasable under at least one predetermined condition, which releases a supply of extinguishing agent through the first end into an interior of the battery housing only when the at least one predetermined condition is met.

2. The motor vehicle as claimed in claim 1, wherein the extinguishing agent line is designed in such a way that when the extinguishing agent reservoir having an extinguishing agent accommodated in the extinguishing agent reservoir is coupled to the coupling element and when the at least one predetermined condition is met, the extinguishing agent can automatically be guided into the interior of the battery housing by releasing the closure device.

3. The motor vehicle as claimed in claim 1, wherein the coupling element is designed as part of a quick coupling.

4. The motor vehicle as claimed in claim 1, wherein the closure device is integrated in the coupling element.

5. The motor vehicle as claimed in claim 1, wherein the first condition is met when a critical state of the at least one battery cell is detected according to a predetermined criterion, in particular when a temperature inside the battery housing is greater than a predetermined limiting value, which is between 60° C. and 80° C. inclusive.

6. The motor vehicle as claimed in any claim 1, wherein the coupling element is designed for coupling to an extinguishing agent reservoir designed as a fire extinguisher, in particular a lithium-ion fire extinguisher.

7. The motor vehicle as claimed in claim 1, wherein the region of the motor vehicle is arranged under a seat of the motor vehicle, in particular a front seat, and/or in the region of a center console of the motor vehicle and/or in the region of the rear center console of the motor vehicle and/or in a footwell on the front passenger side of the motor vehicle and/or in a luggage compartment of the motor vehicle.

8. The motor vehicle as claimed in claim 1, wherein the motor vehicle has a second extinguishing agent line for guiding an extinguishing agent, which line comprises a third end which opens into the battery housing or into the first extinguishing agent line, and a fourth end which opens into a second region of the motor vehicle which is accessible to a user and is arranged in an interior of the motor vehicle, wherein the fourth end has a second coupling element for reversible coupling to an extinguishing agent reservoir.

9. The motor vehicle as claimed in claim 1, wherein the extinguishing agent line has an intermediate reservoir which can be filled with extinguishing agent via the extinguishing agent reservoir coupled to the coupling element, wherein the closure device is arranged in a line region of the extinguishing agent line between the intermediate reservoir and the first end of the extinguishing agent line.

10. A method for introducing an extinguishing agent into a battery for a motor vehicle, wherein the extinguishing agent is guided into the battery via an extinguishing agent line, wherein the extinguishing agent line comprises a first end, which opens at least into a battery housing of the battery and has a second end which opens into a region of the motor vehicle which is arranged in an interior of the motor vehicle, wherein a coupling element of the second end is coupled to an extinguishing agent reservoir comprising the extinguishing agent, and a closure device of the extinguishing agent line releasable under at least one predetermined condition is opened when the at least one predetermined condition is met, in order to enable the extinguishing agent to be supplied into an interior of the battery housing.

11. The motor vehicle as claimed in claim 2, wherein the coupling element is designed as part of a quick coupling.

12. The motor vehicle as claimed in claim 2, wherein the closure device is integrated in the coupling element.

13. The motor vehicle as claimed in claim 3, wherein the closure device is integrated in the coupling element.

14. The motor vehicle as claimed in claim 2, wherein the first condition is met when a critical state of the at least one battery cell is detected according to a predetermined criterion, in particular when a temperature inside the battery housing is greater than a predetermined limiting value, which is between 60° C. and 80° C. inclusive.

15. The motor vehicle as claimed in claim 3, wherein the first condition is met when a critical state of the at least one battery cell is detected according to a predetermined criterion, in particular when a temperature inside the battery housing is greater than a predetermined limiting value, which is between 60° C. and 80° C. inclusive.

16. The motor vehicle as claimed in claim 4, wherein the first condition is met when a critical state of the at least one battery cell is detected according to a predetermined criterion, in particular when a temperature inside the battery housing is greater than a predetermined limiting value, which is between 60° C. and 80° C. inclusive.

17. The motor vehicle as claimed in any claim 2, wherein the coupling element is designed for coupling to an extinguishing agent reservoir designed as a fire extinguisher, in particular a lithium-ion fire extinguisher.

18. The motor vehicle as claimed in any claim 3, wherein the coupling element is designed for coupling to an extinguishing agent reservoir designed as a fire extinguisher, in particular a lithium-ion fire extinguisher.

19. The motor vehicle as claimed in any claim 4, wherein the coupling element is designed for coupling to an extinguishing agent reservoir designed as a fire extinguisher, in particular a lithium-ion fire extinguisher.

20. The motor vehicle as claimed in any claim 5, wherein the coupling element is designed for coupling to an extinguishing agent reservoir designed as a fire extinguisher, in particular a lithium-ion fire extinguisher.
